(19) United States
(12) Patent Application Publication
(10) Pub. No.: US 2019/0003612 A1
(43) Pub. Date: Jan. 3, 2019

(54) TWO-WAY TWO POSITION IN-LINE VALVE

(71) Applicant: Gebhard Charles Wager, Kelowna (CA)

(72) Inventor: Gebhard Charles Wager, Kelowna (CA)

(21) Appl. No.: 16/021,536

(22) Filed: Jun. 28, 2018

Related U.S. Application Data
(60) Provisional application No. 62/525,895, filed on Jun. 28, 2017.

(51) Int. Cl. F16K 31/122; F16K 17/04

(52) U.S. Cl. CPC F16K 31/1221; F16K 17/04

(57) ABSTRACT

A two-way, two position, in-line valve, for controlling fluid flow through a line in both directions. The valve includes a tubular conduit defining a bore there-through to communicate fluid flow from the line and through the bore of the tubular conduit, a piston sized to slide along the bore, a stop in the bore having an annular seal supported on the stop in opposed facing relation to a first face of the piston, a resilient spring mounted in the bore so as to bear against a second face of the piston, opposite the first face, and to thereby resiliently urge the first face of the piston against the seal, and a selectively retracting latching mechanism adapted to index the piston between open and closed positions as in-line modulated pressure is applied to the piston.

### CROSS REFERENCE TO RELATED APPLICATIONS

This application claims priority from U.S. Provisional Patent Application No. 62/525,895, filed on Jun. 28, 2017 entitled “TWO-WAY TWO POSITION IN-LINE VALVE”, entirety of which is incorporated herein by reference.

### FIELD

The present disclosure relates to two-way, two position, in-line valves, specifically to pressure activated two-way in-line valves for use in confined areas.

### BACKGROUND

There exists a need for controlling two way pressure in the vessel through a single air or other fluid line. Consequently, the present disclosure provides for a pressure activated, two-way, two position in-line valve for applications where pressure is to be controlled as close to the vessel as possible and where space limitations prevent the use of prior art valves where the applications will only allow for one air or fluid line requiring air or fluid flow in both directions along the line.

Both solenoid valves and electric valves are known in the prior art. Solenoid valves are operated electromagnetically. Solenoids create a magnetic field from electric current which in turn opens or closes the valve mechanically. Electric valves are driven by electric motors to produce valve action. Both solenoid and electric valves depend on electric current.

The in-line valve according to the present disclosure is pressure activated and does not require energy usage. The in-line valve is advantageous where there is no electricity readily available in proximity to the line so as to operate prior art electric valves or where the operation of such valves would be cost prohibitive or require unreliable rotating electrical contacts. Solenoid and electric valves generally include several structural components, may be large in size, and are usually not suitable for confined spaces.

Solenoid and electric valves generally include several structural components, may be large in size, and are usually not suitable for confined spaces.

The present disclosure is directed to in-line valves where reduced weight is important and wherein, in some applications, the in-line valve may be used in somewhat harsh environments which may cause the fluid line to fail thereby causing subsequent fluid leakage, and where pressure in the line may not always be maintained. For example, the valve according to the present disclosure may be used in place of rotating seals where expected leakage through such rotating seals may exceed design requirements or in situations where reliance on such rotating seals may cause safety concerns or for example reliability problems due to heat build-up and wear in the rotating seals.

### SUMMARY

The present disclosure relates to a two-way, two position, in-line valve, which is activated by in-line fluid pressure, and does not require external sources of electrical energy. The valve depends for operation on the pressure and flow of a liquid or air in a sealed environment. The valve is fluidic; for example for pneumatic or liquid state fluids. In an open position, the valve permits fluid flow through the fluid line, and in a closed position, the valve blocks fluid flow through the fluid flow. The valve is compact and may be scalable to the size of the line in which the valve is intended to be mounted.

### BRIEF DESCRIPTION OF DRAWINGS

FIG. 1 is a sectional view of an in-line valve of the present disclosure in a closed position.

FIG. 2 is a sectional view of the valve of FIG. 1 in an open position.

FIG. 3 is a sectional view of the valve of FIG. 1 illustrating a selectively retractable latching mechanism of an embodiment of the present disclosure superimposed onto the sectional view of the valve.

### DETAILED DESCRIPTION

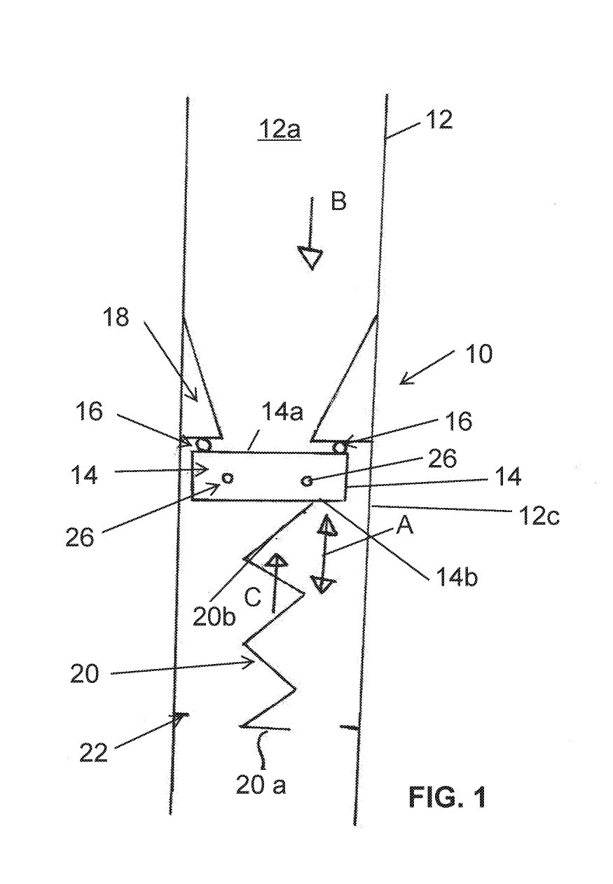

As seen in FIG. 1, the two-way, two position in-line valve 10 is mounted into the bore of a section of fluid line 12; wherein as used and claimed herein the term “fluid” is intended to refer to both pneumatic fluids, such as air or other gases, and/or liquid state fluids such as incompressible liquids. Valve 10 includes a piston 14 which is a somewhat snug fit in the inner bore 12a of line 12 and is free to translate along the bore in direction A between the following constraints:
(1) a first side 14a of piston 14 is in opposed facing relation to a seal 16, which for example may be an annular ring mounted in or against a plurality or single annular stop 18; and,
(2) an opposite second side 14b of piston 14 is engaged against a resilient spring 20. A base end 20a of spring 20 may be rigidly held in place within bore 12a by an annular spring retainer ring 22. The opposite, piston engaging end 20b of spring 20 resiliently engages against side 14b of piston 14 so as to urge piston 14 against seal 16. In that closed position, as seen in FIG. 1, fluid flow through bore 12a and past seal 16 is blocked.

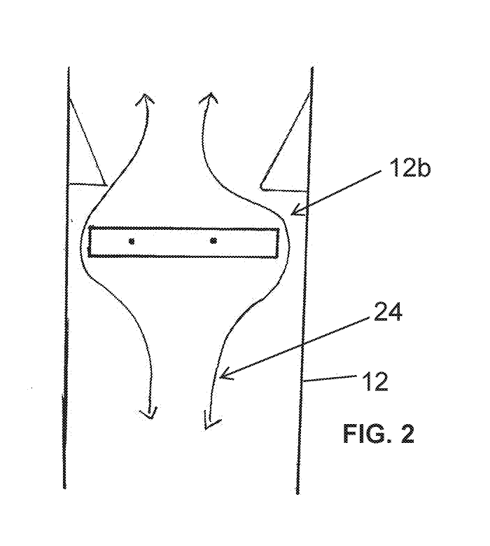

Fluid pressure acting in direction B in bore 12a applies pressure against side 14a on piston 14. Once the pressure acting against piston 14 exceeds the biasing spring force in direction C of spring 20, piston 14 moves away from seal 16, thereby opening a fluid passage, such as an annular passageway 12b as seen in FIG. 2. In that open position, fluid is permitted to flow 24 past seal 16, and around the annular gap thereby caused between stop 18, piston 14, and the walls of line 12.

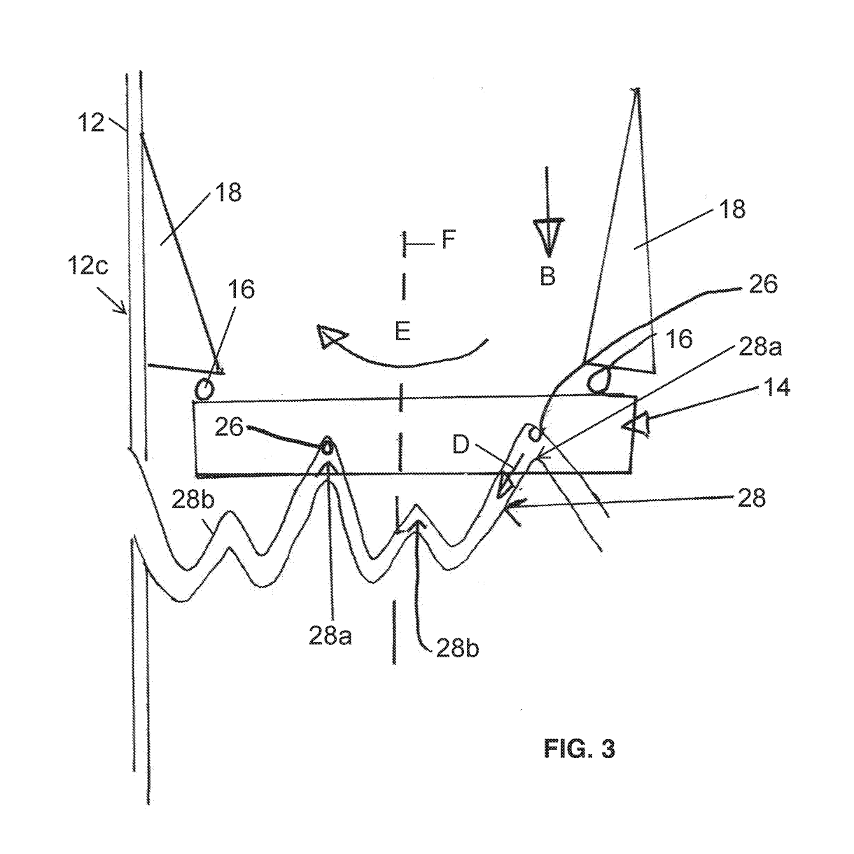

A retractable mechanism is utilized to lock the piston in the open position. It will be appreciated by a person skilled in the art that various selectively retractable latching mechanisms may be utilized to releasably lock or latch the piston in the open position. For example, without intending to be limiting, a cam and follower type retractable latch mechanism may be used, as shown by way of example in FIG. 3. In FIG. 3, guide pins 26 protrude from piston 14 and engage into a cam track 28. As illustrated, track 28 may be an undulating track which extends circumferentially around the entire inner circumference of the section 12c of line 12 adjacent piston 14. Pins 26 function as cam followers moving along track 28. Track 28 functions as a cam surface. Pins 26 follow along track 28 as piston 14 is depressed in the direction of pressure B. As pins 26 are forced along track 28 in direction B piston 14 is caused to rotate in direction E about the longitudinal axis F of line section 12c.

Track 28 has alternating high and low vertices 28a and 28b respectively. If the guide pins 26 are in a section of track 28 leading to vertex 28a when the pressure in direction B is relieved, the return biasing force of spring 20 in direction C will urge pins 26 into the corresponding vertices 28a in track 28 thus returning piston 14 to the closed position of FIG. 1. If the guide pins 26 are in a section of track 28 leading to vertices 28b, then a release of the pressure acting on piston 14 in direction B allows the resilient biasing force of spring 14 to urge guide pins 26 into vertices 28b thereby temporarily locking piston 14 in the open position of FIG. 2.

Thus it will be appreciated that every time a fluid or air pressure exceeding the spring force of spring 20 is applied in direction B, for example by the fluid pressure being selectively modulated to actuate the valve, that the guide pins 26 are cycled along track 28 between their piston-closed position in vertices 28a and their piston-open position in vertices 28b. This allows for pulsing modulation of pressure in the line to bias and index piston 14 between its open and closed positions, and when in those positions the spring force of spring 20 locking piston 14 in either the open or closed position as the fluid pressure in direction B is lessened or removed.

The in-line valve of the present disclosure may be used in various industries. For example, in oil and gas, the valve may be used to control oil pressure in an oil path. In addition, and without intending to be limiting, in an application where valve 10 is mounted in-line in an air hose, air pressure may be used to control the actuation of valve 10 which then allows for the inflation of a tire mounted on a corresponding hub and wheel, or for the deflation of the tire as needed. In one embodiment, as the air pressure causes the depression of piston 14 away from seal 16, thereby causing pins 26 to follow along track 28 as piston 14 correspondingly rotates, when pins 26 are at their lowest point in the track, inflation of the tire is then taking place. When the pressure is released and the pin is forced by spring 20 to a mid-point along the track, deflation of the tire then takes place. When the pressure is again applied to piston 14, inflation can take place, and if the pressure is released, piston 14 is then returned to its closed and sealed position.

What is claimed is:

1. A two-way, two position valve for mounting in-line, in a pressurized fluid line, comprising:
a tubular conduit defining a bore there-through to communicate fluid flow from the line and through the bore of the tubular conduit,
a piston sized to slide along the bore,
a stop in the bore, having an annular seal supported on the stop in opposed facing relation to a first face of the piston,
a resilient spring mounted in the bore so as to bear against a second face of the piston, opposite the first face, and to thereby resiliently urge the first face of the piston against the seal, and
a selectively retractable latching mechanism adapted to index the piston between open and closed positions as in-line modulated fluid pressure is applied to the piston.

2. The valve of claim 1, wherein the retracting latching mechanism comprises a cam surface and cam follower cooperating between side walls of the piston and bore, thereby causing:
(a) a first rotation of the piston relative to the bore caused by a fluid flow pressure in the bore acting on the first face of the piston so as to resiliently bias the piston, against a returning biasing force of the spring, into the open position wherein fluid flow passes along the bore around the piston and past the seal,
(b) a second rotation of the piston relative to the bore caused by a further fluid flow pressure in the bore acting on the first face of the piston, again against the return biasing force of the spring, into the closed position wherein fluid flow along the bore is prevented.

3. The valve of claim 2 wherein the cam surface is an undulating track.

4. The valve of claim 2 wherein the cam follower is guide pins.

5. The valve of claim 1 wherein in the closed position, the piston is flush against the seal.

6. The valve of claim 2 wherein in the open position, the piston is separated from the seal.

7. The valve of claim 1 wherein the valve is a pneumatic valve.

8. The valve of claim 1 wherein the valve is a liquid valve.

9. The valve of claim 1 wherein the stop is an annular stop extending around an internal circumference of the bore.

10. The valve of claim 1 wherein actuation of the valve is controlled by pressure.

11. The valve of claim 7 wherein the valve is adapted to be mounted in-line in an air hose so as to be used to inflate or deflate a tire.

12. A method for maintaining seal integrity, the seal supported on a stop, the stop and seal located within a bore defined by a tubular conduit within a pressurized fluid line, the method comprising the steps of:
mounting the in-line valve of claim 1 within the bore,
applying pressure to the first face of the piston so as to bias the resilient spring away from the seal,
releasably locking the piston in the open position so as to allow fluid flow through the bore,
removing pressure to the first face of the piston so as to bias the resilient spring and piston towards the seal, preventing fluid flow through the bore.

13. A method for controlling fluid flow in two directions, the method comprising the steps of:
mounting the in-line valve of claim 1 within a bore of a tubular conduit of a pressurized line,
applying pressure to the first face of the piston so as to bias the resilient spring away from the seal,
releasably locking the piston in the open position so as to allow fluid flow through the bore,
removing pressure to the first face of the piston so as to bias the resilient spring and piston towards the seal, preventing fluid flow through the bore.
